(19) United States
(12) Patent Application Publication
(10) Pub. No.: US 2026/0160650 A1
(43) Pub. Date: Jun. 11, 2026

(54) PATHOLOGY DEVICES, SYSTEMS, AND METHODS

(71) Applicant: PARKER ISAAC INSTRUMENTS LLC, Ithaca, NY (US)

(72) Inventors: Alexander BODELL, Ithaca, NY (US); Katelin BRANDEGEE, New York, NY (US); Ian PERKINS, Hood River, OR (US)

(21) Appl. No.: 19/264,364

(22) Filed: Jul. 9, 2025

Related U.S. Application Data
(63) Continuation of application No. PCT/US2024/011081, filed on Jan. 10, 2024.
(60) Provisional application No. 63/479,473, filed on Jan. 11, 2023.

(51) Int. Cl. G01N 1/28

(52) U.S. Cl. CPC G01N 1/286

(57) ABSTRACT

Described are devices, systems, and methods for separating lymph nodes from surrounding fat tissue, e.g., adipose tissue, in a tissue sample. Devices can include a compression chamber having an expanded state and a compressed state. A compression chamber can include a base comprising a base filtration opening therethrough. An upper surface of the base can include a tissue template. The compression chamber can include two or more walls extending from the base. At least one of the two or more walls can include a wall filtration opening therethrough. Two of the walls can be detachably coupled in the expanded state. The compression chamber can include a plunger. At least a proximal portion of the plunger can be removably receivable within the cavity.

### CROSS-REFERENCE TO RELATED APPLICATIONS

This application is a continuation application of International Application No. PCT/US2024/011081, filed Jan. 10, 2024, which claims the benefit of U.S. Provisional Application No. 63/479,473, filed Jan. 11, 2023, each of which is incorporated by reference herein in its entirety.

### BACKGROUND

Cancer diagnosis and staging can be performed by obtaining a tissue sample from a subject and determining or identifying a number of lymph nodes from cross sections of the tissue sample. To determine or identify lymph nodes more easily and to improve the total number of lymph nodes isolated, fat (e.g., adipose) can be removed from the tissue sample. Further, to improve accuracy in or resolution of determining or identifying lymph nodes in metastatic cancers, it can be useful to substantially maintain the morphology of the lymph nodes as fat is removed.

### SUMMARY

In an aspect, the present disclosure provides a device for preparing a tissue sample, the device comprising: a compression chamber having an expanded state and a compressed state, the compression chamber comprising: a base comprising a base filtration opening therethrough, wherein an upper surface of the base comprises a tissue template; and two or more walls extending from the base, wherein at least one of the two or more walls comprises a wall filtration opening therethrough, and wherein two of the walls are detachably coupled in the expanded state; and a plunger, wherein at least a proximal portion of the plunger is removably receivable within the cavity.

In some embodiments, the base comprises an array of the base filtration openings therethrough. In some embodiments, one or more of the walls comprises an array of the wall filtration openings. In some embodiments, the array of base filtration openings, the array of wall filtration openings, or both, comprise a polar array, a rectilinear array, a polygonal array, or an irregular array. In some embodiments, the array of base filtration openings and the array of wall filtration opening array are congruent. In some embodiments, the array of base filtration openings and the array of wall filtration opening array are incongruous. In some embodiments, the tissue template is removable from the base. In some embodiments, the tissue template comprises a plurality of chambers. In some embodiments, the plurality of chambers comprise an array of chambers. In some embodiments, the array of chambers comprises a polar array, a rectilinear array, a polygonal, or an irregular array. In some embodiments, an upper face of the two or more walls comprises a wall chamfer. In some embodiments, an outer face of the plunger comprises a wall chamfer. In some embodiments, the two or more walls are reattachable. In some embodiments, two of the walls are detachably coupled by a perforation or tear line. In some embodiments, at least one of the two or more walls comprises a flexure portion and a rigid portion, and wherein the flexure portion is thinner than the rigid portion. In some embodiments, at least a part of the flexure portion is parallel to the base. In some embodiments, at least one of the two or more walls comprises a plurality of flexure portions, wherein at least two of the plurality of flexure portions are parallel. In some embodiments, a ratio between a width, a length, or both of the base to a diameter of the base filtration opening is about 40:1 to about 120:1. In some embodiments, a ratio between a width, a length, or both of the two or more walls to a diameter of the wall filtration opening is about 30:1 to about 70:1. In some embodiments, a ratio between the total surface area of the upper surface of the base and a total surface area of the base filtration openings is about 2:1 to about 15:1. In some embodiments, the device has a height in the collapsed state of less than the height in the expanded state by at least about 10% to about 75%. In some embodiments, the device further comprises an RFID tag, a barcode, a QR code, a Bluetooth device, a Wi-Fi device, or any combination thereof. In some embodiments, the device is configured to achieve a Nodal Staging Score (NSS) of greater than or equal to 95% on at least about 50% of samples tested. In some embodiments, the device is configured to achieve an NSS of greater than or equal to 90% on at least about 85% of samples tested. In some embodiments, the device is configured to extract at least about 50% more lymph nodes per volume than extraction by manual dissection.

In another aspect, the present disclosure provides a system for collecting a tissue sample, the system comprising: the device for collecting a tissue sample, herein; a fat drainage dish removably coupled to the device; and a compression platform supporting the fat drainage dish. In some embodiments, the fat drainage dish is removably coupled to the device by a snap fit, a dowel rod, a magnet, or any combination thereof. In some embodiments, the fat drainage dish comprises a plurality of channels for collecting the drained fat. In some, embodiments, the system is configured to achieve a Nodal Staging Score (NSS) of greater than or equal to 95% on at least about 50% of samples tested. In some, embodiments, the system is configured to achieve an NSS of greater than or equal to 90% on at least about 85% of samples tested. In some, embodiments, the system is configured to extract at least about 50% more lymph nodes per volume than extraction by manual dissection.

In another aspect, the present disclosure provides a method of collecting a tissue sample, the method comprising: (a) receiving the system for collecting a tissue sample herein; (b) receiving the tissue sample; (c) applying the tissue sample to the base of the compression chamber; (d) positioning at least the portion of the plunger within the cavity; (e) positioning the compression chamber on the fat drainage dish; (f) positioning the fat drainage dish on the compression platform; and (g) applying pressure to the plunger. In some embodiments, the applied pressure is a pressure selected to compress a tissue sample, such as a lymph node sample. In some embodiments, the applied pressure is a pressure selected to compress a tissue sample with a pressure of at least about 200 psi. In some embodiments, applying pressure to the plunger transforms the compression chamber from the expanded state to the compressed state. In some embodiments, the method further comprises applying a solvent to the tissue. In some embodiments, the tissue template divider separates the tissue sample into two or more portions. In some embodiments, the method achieves a Nodal Staging Score (NSS) of greater than or equal to 95% on at least about 50% of samples tested. In some embodiments, the method achieves an NSS of greater than or equal to 90% on at least about 85% of samples tested. In some embodiments, the method extracts at least about 50% more lymph nodes per volume than extraction by manual dissection.

In another aspect, the present disclosure provides a sample collection device for collecting a tissue sample, the sample collection device comprising a compression chamber defining a sample reservoir for receiving a sample, the compression chamber having collapsible side walls defining an interior space, a top open end, and a bottom end plate, wherein the bottom end plate of the compression chamber.

In some embodiments, the compression chamber has connected collapsible side walls and wherein the corners between each of the connected collapsible side walls are constructed to break, permitting the side walls to peel away from the interior space as a tissue compressing pressure is applied to the compression chamber. In some embodiments, the corners comprise a plurality of perforations in each corner constructed to break as a tissue compressing pressure is applied to the compression chamber. In some embodiments, the corners comprise a tear line or plurality of tear lines in each corner constructed to break as a tissue compressing pressure is applied to the compression chamber. In some embodiments, the collapsible side walls of the compression chamber are configured to fold into a plurality of horizontal accordion-like folds as a tissue compressing pressure is applied to the compression chamber. In some embodiments, the collapsible side walls further comprise a plurality of filtration openings. In some embodiments, the interior chamber is divided into a plurality of sub-divided chambers, wherein each of the sub-divided chambers comprises a plurality of dividing walls extending from the bottom end plate. In some embodiments, the interior space of the chamber is divided into 2 to 24 equally divided sub-chambers. In some embodiments, the interior space of the chamber is divided into 4 to 16 equally divided sub-chambers. In some embodiments, the interior space of the chamber is divided into 8 to 12 equally divided sub-chambers. In some embodiments, each of the sub-chambers has a size of from 1 cm×1 cm to about 6 cm×6 cm. In some embodiments, each of the sub-chambers has a size of from 2 cm×2 cm to about 4 cm×4 cm. In some embodiments, the each of the sub-divided chambers has a depth of from about 1 mm to about 20 mm. In some embodiments, the each of the sub-divided chambers has a depth of from about 2 mm to about 10 mm. In some embodiments, the interior space of the compression chamber has a volume from about 1 to 20 cubic inches. In some embodiments, the interior space of the compression chamber has a volume from about 2 to 16 cubic inches. In some embodiments, the interior space of the compression chamber has a volume from about 4 to 12 cubic inches. In some embodiments, the filtration openings in the bottom end plate and/or in the collapsible side walls are from about 1 to about 5 mm in diameter. In some embodiments, the sample collection device is configured to achieve a Nodal Staging Score (NSS) of greater than or equal to 95% on at least about 50% of samples tested. In some embodiments, the sample collection device is configured to achieve an NSS of greater than or equal to 90% on at least about 85% of samples tested. In some embodiments, the sample collection device is configured to extract at least about 50% more lymph nodes per volume than extraction by manual dissection.

In another aspect, the present disclosure provides a filtration assembly for filtering a tissue sample, the filtration assembly comprising: a compression chamber defining a sample reservoir for receiving a tissue sample, the compression chamber having collapsible side walls, a hollow body defining an interior space, a top open end and a bottom end plate; wherein the bottom end plate of the compression chamber comprises a plurality of substantially equally divided sub-chambers; and wherein the bottom end plate of the chamber comprises a plurality of filtration openings; and a means for applying a tissue compressing pressure to a tissue sample contained within the sample reservoir so as to force a liquid component of the tissue sample through the filtration openings while retaining a solid component of the tissue sample within each of the sub-chambers. In some embodiments, the means for applying a pressure comprises a plunger and a means for applying a predetermined force to the plunger so as to force the plunger toward the bottom end plate of the compression chamber. In some embodiments, the plunger is disposed within the chamber. In some embodiments, the plunger further comprises an outer ledge, wherein when the plunger is within the compression chamber, the outer ledge is adjacent to the collapsible side walls, and wherein during operation the outer ledge is operable to collapse the collapsible side walls. In some embodiments, the means for applying pressure to the tissue sample compresses the solid component of the tissue sample to a predetermined depth. In some embodiments, the compression chamber has four connected collapsible side walls and wherein the corners between each of the connected collapsible side walls are constructed to break, permitting the side walls to peel away from the interior space as a tissue compressing pressure is applied to the compression chamber. In some embodiments, the compression chamber has four connected collapsible side walls and wherein the corners between each of the connected collapsible side walls comprise perforations and/or tear lines that are constructed to break, permitting the side walls to peel away from the interior space as a tissue compressing pressure is applied to the compression chamber. In some embodiments, the collapsible side walls of the compression chamber are configured to fold into a plurality of horizontal accordion-like folds as a tissue compressing pressure is applied to the compression chamber. In some embodiments, the collapsible side walls further comprise a plurality of filtration openings. In some embodiments, the interior chamber is divided into a plurality of sub-divided chambers, wherein each of the sub-divided chambers comprises a plurality of side walls extending from the bottom end plate. In some embodiments, the sample reservoir/chamber is divided into 2 to 24 equally divided sub-chambers. In some embodiments, the sample reservoir/chamber is divided into 4 to 16 equally divided sub-chambers. In some embodiments, the sample reservoir/chamber is divided into 8 to 12 equally divided sub-chambers. In some embodiments, each individual sub-chamber has a size of from 1 cm×1 cm to about 6 cm×6 cm. In some embodiments, each individual sub-chamber has a size of from 2 cm×2 cm to about 4 cm×4 cm. In some embodiments, the each of the sub-divided chambers has a depth of from about 1 mm to about 20 mm. In some embodiments, the each of the sub-divided chambers has a depth of from about 2 mm to about 10 mm. In some embodiments, the interior space of the compression chamber has a volume from about 1 to 20 cubic inches. In some embodiments, the interior space of the compression chamber has a volume from about 2 to 16 cubic inches. In some embodiments, the interior space of the compression chamber has a volume from about 4 to 12 cubic inches. In some embodiments, the filtration openings in the bottom end plate and/or in the collapsible side walls are from about 1 mm in diameter to about 5 mm in diameter. In some embodiments, the filtration assembly is configured to achieve a Nodal Staging Score (NSS) of greater than or equal to 95% on at least about 50% of samples tested. In some embodiments, the filtration assembly is configured to achieve an NSS of greater than or equal to 90% on at least about 85% of samples tested. In some embodiments, the filtration assembly is configured to extract at least about 50% more lymph nodes per volume than extraction by manual dissection.

In another aspect, the present disclosure provides a filtration assembly comprising: a sample collection device having a hollow body defining an interior chamber, a top open end, and a bottom end plate, wherein the chamber extends vertically from the top open end to the bottom end plate, the body comprises four collapsible side walls, and wherein the bottom end plate comprises a plurality of filtration openings; a compression container having a hollow body, wherein the hollow body is operable to hold the sample collection device, and wherein the compression container comprises one or more fluid flow channels for collecting a liquid component filtrate obtained from a tissue sample as a tissue compressing pressure is applied to the compression chamber; a filtrate collection tube having a hollow body defining an interior space and an opening communicating with the interior space to collect the liquid component filtrate from a tissue sample. In some embodiments, the filtration assembly further comprises an attachment feature operable for attaching the filtrate collection tube to the compression container. In some embodiments, the filtration assembly does not comprise the attachment feature. In some embodiments, the filtration assembly further comprises a means for applying pressure to a tissue sample contained within the sample reservoir so as to force a liquid component of the tissue sample through the filtration openings while retaining a solid component of the tissue sample within each of the sub-chambers. In some embodiments, the means for applying a pressure comprises a plunger and a means for applying a predetermined force to the plunger so as to force the plunger toward the bottom end plate of the compression chamber. In some embodiments, the plunger is disposed within the chamber. In some embodiments, the plunger further comprises an outer ledge, wherein when the plunger is within the compression chamber, the outer ledge is adjacent to the collapsible side walls, and wherein during operation the outer ledge is operable to collapse the collapsible side walls. In some embodiments, the means for applying pressure to the tissue sample compresses the solid component of the tissue sample to a predetermined depth. In some embodiments, the compression chamber has four connected collapsible side walls and wherein the corners between each of the connected collapsible side walls are constructed to break, permitting the side walls to peel away from the interior space as a tissue compressing pressure is applied to the compression chamber. In some embodiments, the compression chamber has four connected collapsible side walls and wherein the corners between each of the connected collapsible side walls comprise perforations and/or one or more tear lines that are constructed to break, permitting the side walls to peel away from the interior space as a tissue compressing pressure is applied to the compression chamber. In some embodiments, the collapsible side walls of the compression chamber are configured to fold into a plurality of horizontal accordion-like folds as a tissue compressing pressure is applied to the compression chamber. In some embodiments, the collapsible side walls further comprise a plurality of filtration openings. In some embodiments, the interior chamber is divided into a plurality of sub-divided chambers, wherein each of the sub-divided chambers comprises a plurality of side walls extending from the bottom end plate. In some embodiments, the sample reservoir/chamber is divided into 2 to 24 equally divided sub-chambers. In some embodiments, the sample reservoir/chamber is divided into 4 to 16 equally divided sub-chambers. In some embodiments, the sample reservoir/chamber is divided into 8 to 12 equally divided sub-chambers. In some embodiments, each individual sub-chamber has a size of from 1 cm×1 cm to about 6 cm×6 cm. In some embodiments, each individual sub-chamber has a size of from 2 cm×2 cm to about 4 cm×4 cm. In some embodiments, the each of the sub-divided chambers has a depth of from about 1 mm to about 20 mm. In some embodiments, the each of the sub-divided chambers has a depth of from about 2 mm to about 10 mm. In some embodiments, the interior space of the compression chamber has a volume from about 1 to 20 cubic inches. In some embodiments, the interior space of the compression chamber has a volume from about 2 to 16 cubic inches. In some embodiments, the interior space of the compression chamber has a volume from about 4 to 12 cubic inches. In some embodiments, the filtration openings in the bottom end plate and/or in the collapsible side walls are from about 1 mm diameter to about 5 mm in diameter. In some embodiments, the filtration assembly is configured to achieve a Nodal Staging Score (NSS) of greater than or equal to 95% on at least about 50% of samples tested. In some embodiments, the filtration assembly is configured to achieve an NSS of greater than or equal to 90% on at least about 85% of samples tested. In some embodiments, the filtration assembly is configured to extract at least about 50% more lymph nodes per volume than extraction by manual dissection.

In another aspect, the present disclosure provides a kit for collecting a tissue sample for pathological staging, the kit comprising: the sample collection device or filtration assembly of any one of the preceding claims. In some embodiments, the kit may include a solvent to liquify lipids in the tissue sample. In some embodiments, the kit may be provided with a means for compressing the tissue sample in the compression device.

In another aspect, the present disclosure provides a method of preparing a tissue sample for pathologic staging, the method comprising: providing the sample collection device or the filtration assembly herein; providing a pathologic staging compression device; soaking the tissue sample in a solution to liquify any lipids in the tissue sample; transferring the soaked tissue sample to the interior space of the compression device; compressing the tissue sample in the compression chamber using the pathologic staging compression device; and collecting the filtrate from the compressed tissue sample. In some embodiments, the pathologic staging compression device further comprises: a frame; a hydraulic plunger held by the frame in alignment with the compression chamber; a pump providing pressurized hydraulic fluid to the hydraulic plunger; a pressure sensor measuring a hydraulic pressure of the pressurized hydraulic fluid; and wherein the method further comprises: aligning the hydraulic plunger with the top open end of the compression chamber; and actuating the hydraulic plunger to drive the hydraulic plunger into the interior space and compress the tissue sample into the sub-chambers. In some embodiments, the compression step is directed by an automated control system that actuates and controls an output of a force actuator and monitors a compression force. In some embodiments, the pump comprises a hydraulic pump, an electromechanical pump, a peristaltic pump, or any combination thereof. In some embodiments, the method achieves a Nodal Staging Score (NSS) of greater than or equal to 95% on at least about 50% of samples tested. In some embodiments, the method achieves an NSS of greater than or equal to 90% on at least about 85% of samples tested. In some embodiments, the method extracts at least about 50% more lymph nodes per volume than extraction by manual dissection.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a diagram of an exemplary tissue sample, per one or more embodiments herein;

FIG. 1B shows a diagram of an exemplary compressed tissue sample, per one or more embodiments herein;

FIGS. 2A-2D show an exploded illustration and plan views of an exemplary device for collecting a tissue sample in an expanded state, per one or more embodiments herein. FIG. 2A shows an exploded illustration of an exemplary device, which can include a base, a plunger, a tissue template, and collapsible or rigid side walls. FIG. 2B shows a plan view of an exemplary device sized with a square base having a length and width of about 4 inches by 4 inches for collecting tissue samples of about 80 mm by 80 mm; FIG. 2C shows a plan view of an exemplary device sized with a square base having a length and width of about 3 inches by 3 inches for collecting tissue samples of about 60 mm by 60 mm. FIG. 2D shows a plan view of an exemplary device sized with a rectangular base having a length and width of about 4 inches by 3 inches for collecting tissue samples of about 80 mm by 60 mm;

FIG. 3 shows an exploded illustration of an exemplary device of for collecting a tissue sample in an expanded state, which can include a base, a plunger, an RFID tag, a removeable tissue template, collapsible or rigid side walls, per one or more embodiments herein;

FIG. 4A shows a front-top-right perspective view illustration of an exemplary device for collecting a tissue in a compressed state, which can include a base, a plunger, an RFID tag, and collapsible side walls, per one or more embodiments herein;

FIG. 4B shows a front-bottom-right perspective view illustration of an exemplary device for collecting a tissue in a compressed state, which can include a base, a tissue template, and collapsible side walls, per one or more embodiments herein;

FIG. 4C illustrates different parts or features of an exemplary device, which can be manufactured with different materials or processes, per one or more embodiments herein;

FIG. 5A shows a top-view illustration of an exemplary compression chamber, which can include a single sub-chamber with a plurality of base filtration openings, per one or more embodiments herein;

FIG. 5B shows a top-view illustration of an exemplary compression chamber, which can include more than one sub-chamber with a plurality of base filtration openings, per one or more embodiments herein;

FIG. 6A shows a right-view illustration of an exemplary compression chamber, which can include collapsible or rigid side walls with a plurality of wall filtration openings, per one or more embodiments herein;

FIG. 6B shows a right-view illustration of an exemplary plunger, which can include a tissue template attached thereto, per one or more embodiments herein;

FIG. 7A shows a detailed front-top-right perspective view illustration of an exemplary compression chamber, which can include collapsible or rigid side walls with a plurality of wall filtration openings, per one or more embodiments herein;

FIG. 7B shows a detailed right-view illustration of an exemplary compression chamber, which can include collapsible or rigid side walls with a plurality of wall filtration openings, per one or more embodiments herein;

FIG. 8A shows a top-view illustration of an exemplary tissue template, which can include one or more sub-chambers, per one or more embodiments herein;

FIG. 8B shows a perspective-view illustration of an exemplary tissue template, which can include one or more sub-chambers, per one or more embodiments herein;

FIG. 9A shows an exploded front-top-right perspective view illustration of an exemplary system for collecting a tissue sample, which can include the base, compression chamber, plunger, RFID tag, tissue template, fat drainage dish, compression platform, and control software, per one or more embodiments herein;

FIG. 9B shows a front-top-right perspective view illustration of an exemplary system for collecting a tissue sample, which can include the base, compression chamber, plunger, RFID tag, tissue template, fat drainage dish, compression platform, and control software, per one or more embodiments herein;

FIGS. 10A-10C show perspective view illustrations of an exemplary device for collecting a tissue in a compressed state, which can include one or more snap features for connecting or securing the base to the compression chamber, per one or more embodiments herein. FIG. 10A shows a perspective view of the base and the compression chamber in an unassembled state. FIG. 10B shows a perspective view of the base and compression chamber in an assembled state with the snap features in the open position. FIG. 10C shows a perspective view of the base and compression chamber in an assembled state with the snap features in the closed position; and

FIG. 11 illustrates a process for analyzing tissue samples to identify lymph nodes using wide area mapping or a high resolution tissue mosaic, per one or more embodiments herein.

### DETAILED DESCRIPTION

While various embodiments of the disclosure have been shown and described herein, such embodiments are provided by way of example only. Numerous variations, changes, or substitutions may occur without departing from the disclosure. It should be understood that various alternatives to the embodiments of the disclosure described herein may be employed.

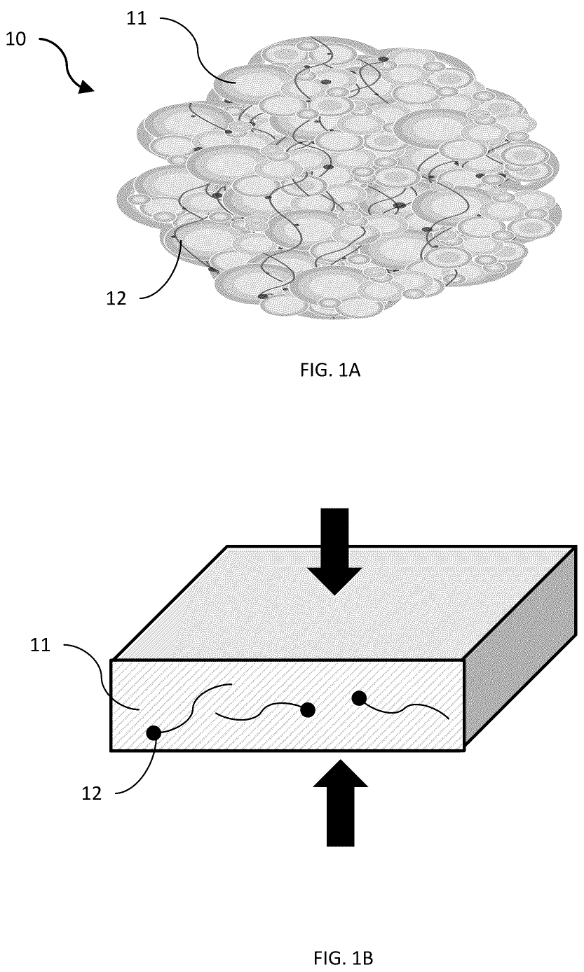

The present disclosure provides devices, systems, and methods for processing a tissue sample. In particular, as illustrated in FIGS. 1A-1B, the disclosure provides devices, systems, and methods for separating fat cells 11 from a tissue sample 10 having lymph nodes 12. Tissue samples can include colorectal tissue, including pericolonic adipose tissue (e.g., fat), peritoneal tissue, retroperitoneal tissue, inguinal tissue, cervical (e.g., neck) tissue from head and neck surgery, mediastinal tissue, axillary tissue, or other adipose tissue samples in the field of surgical resection for any tumor.

In some embodiments, the devices, systems, and methods herein apply compressive force to a tissue sample 10 to filter out fat cells 11 from lymph nodes 12, while preserving lymph node 12 morphology. A user may slice the compressed tissue sample 10 and count the number of lymph nodes 12 that are visible to determine a diagnosis. In some cases, the determination is based in part on a Nodal Staging Score (NSS) or guidelines from the American Joint Committee on Cancer (AJCC).

### Devices for Collecting or Processing a Tissue Sample

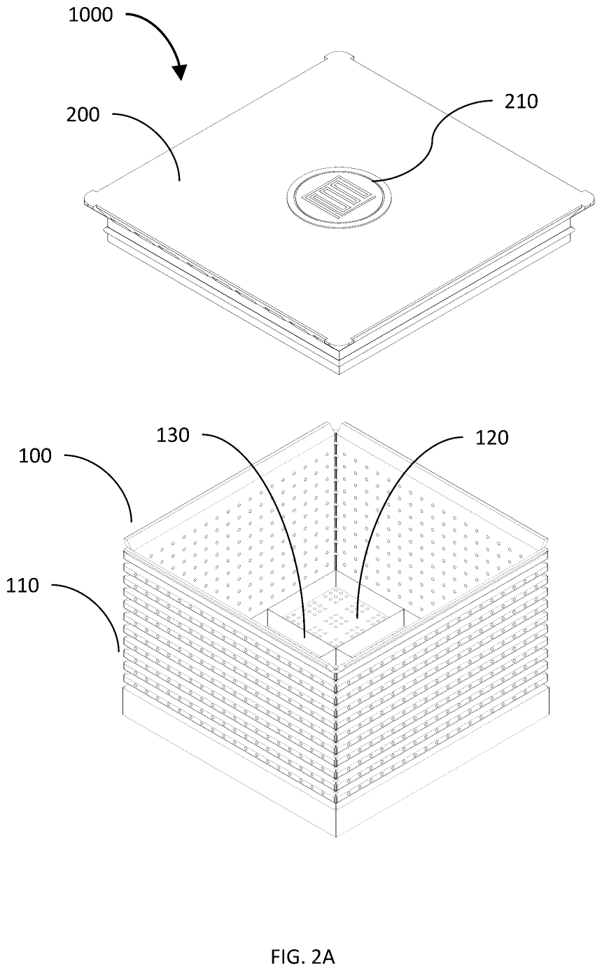

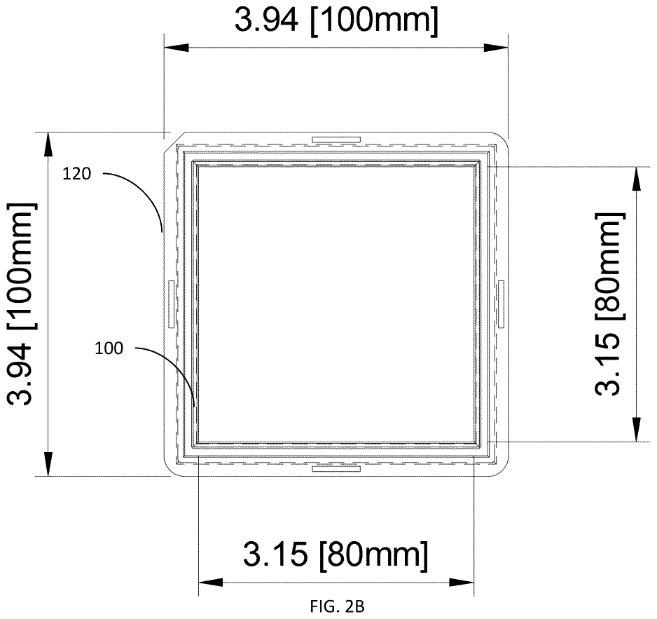

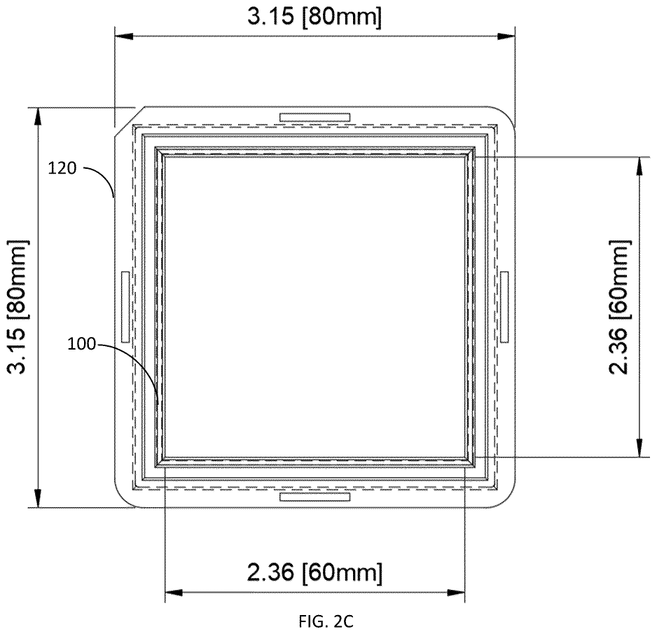

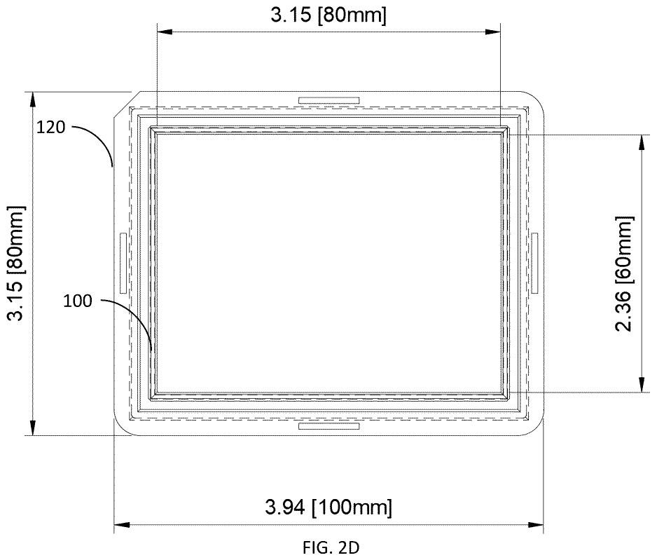

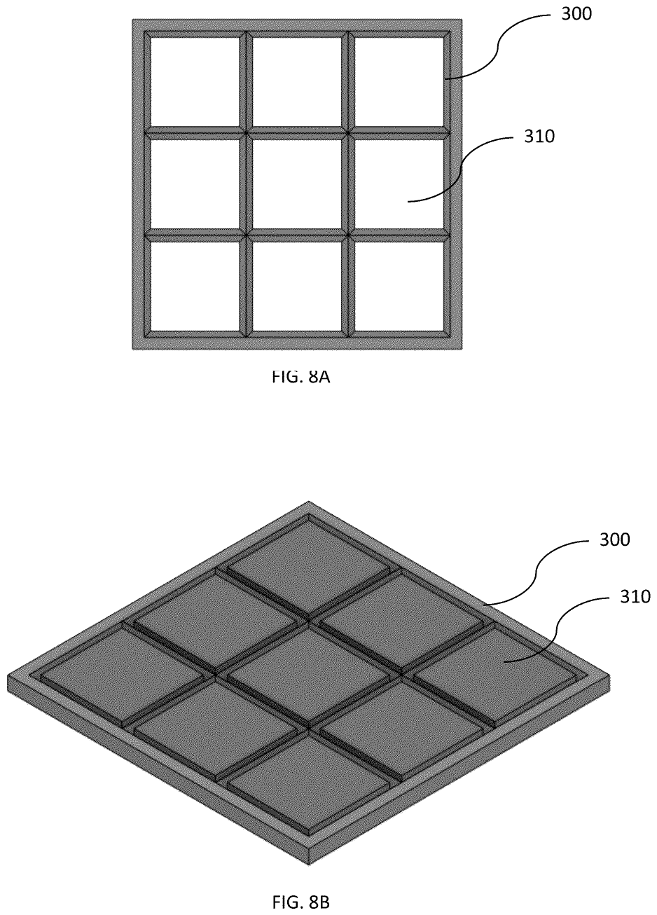

FIGS. 2A-10C illustrate a device 1000 of for collecting a tissue sample. In some cases, the device 1000 can comprise the sample collection device or the filtration assembly described herein elsewhere. In some embodiments, the device 1000 comprises a compression chamber 100 and a plunger 200. In some embodiments, the device 1000 or its packaging further comprises a radio frequency identification (RFID) tag 210, a barcode, a QR code, a Bluetooth device, embossed text or other features, printed label, or any combination thereof. The RFID tag 210, barcode, QR code, Bluetooth device, embossed text or other features, printed label, or any combination thereof, may be used to identify a specific tissue sample.

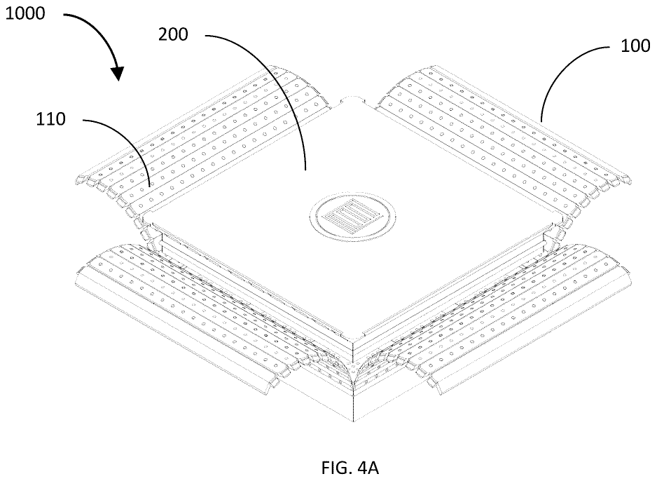

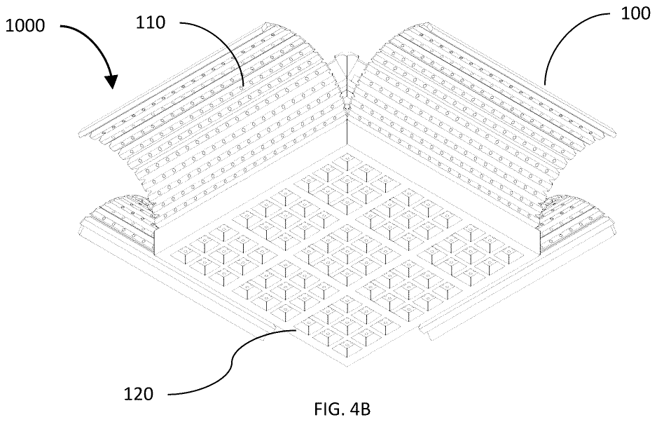

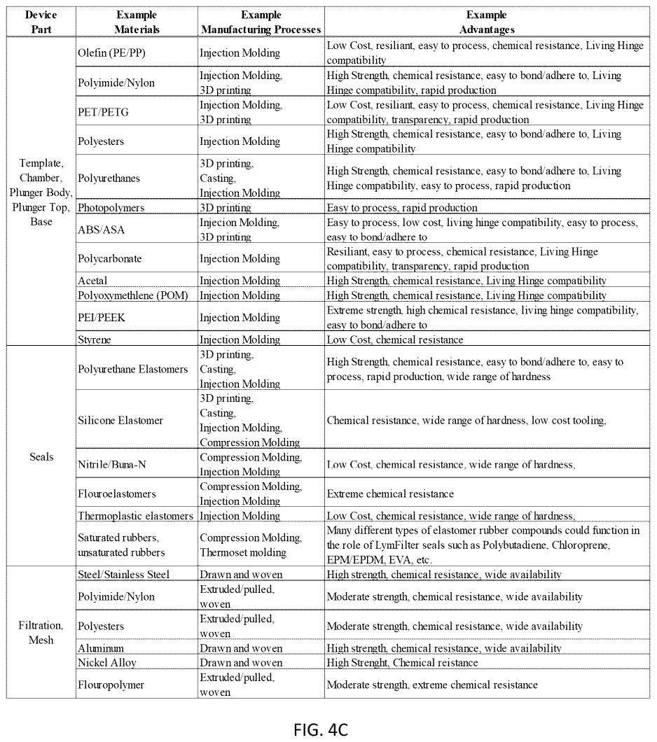

Device 1000, including compression chamber 100 and plunger 200, may be made from any suitable material. Materials can be selected to be compatible with the function of device 1000, e.g., capable of withstanding compression pressures required for processing tissue samples and selected to avoid sample contamination that can interfere with downstream processing. In some cases, different parts or features of the device 1000, such as the base 120, the compression chamber 100, the side walls 110, the plunger 200, and operating seals can be manufactured with different materials or processes as described in FIG. 4C.

The compression chamber 100 may have an expanded state, as illustrated in FIG. 2A, and a compressed state, as illustrated in FIGS. 4A-4B. In some embodiments, the geometry of the compression chamber 100 is optimized for a particular type of tissue sample (e.g., lymph tissue associated with breast cancer). The ratio between the height of the device 1000 in the collapsed state and the height in the expanded state may be selected to remove the greatest percentage of fat tissue from the sample with a single compression. The ratio between the height of the device 1000 in the collapsed state and the height in the expanded state is tuned for a specific tissue sample type based on a ratio between the fat tissue and the fibrous tissue in the sample tissue. In some cases, the ratio can be tuned for histologic embedding. In some cases, the ratio is expressed as a percentage by comparing a height in the collapsed state to a height in the expanded sate. In some cases, the compression chamber 100 can have connected side walls that are not configured to collapse. For example, the side walls may be substantially rigid and configured to withstand collapsing under the applied tissue compressive force. In some cases, the compression chamber 100 can have connected side walls with one or more side walls configured to collapse and one or more side walls configured not to collapse.

In some embodiments, the device 1000 has a height in the collapsed state of less than the height in the expanded state by about 10% to about 75%. In some embodiments, the device 1000 has a height in the collapsed state of less than the height in the expanded state by about 10% to about 15%, about 10% to about 20%, about 10% to about 25%, about 10% to about 30%, about 10% to about 35%, about 10% to about 40%, about 10% to about 45%, about 10% to about 50%, about 10% to about 60%, about 10% to about 75%, about 15% to about 20%, about 15% to about 25%, about 15% to about 30%, about 15% to about 35%, about 15% to about 40%, about 15% to about 45%, about 15% to about 50%, about 15% to about 60%, about 15% to about 75%, about 20% to about 25%, about 20% to about 30%, about 20% to about 35%, about 20% to about 40%, about 20% to about 45%, about 20% to about 50%, about 20% to about 60%, about 20% to about 75%, about 25% to about 30%, about 25% to about 35%, about 25% to about 40%, about 25% to about 45%, about 25% to about 50%, about 25% to about 60%, about 25% to about 75%, about 30% to about 35%, about 30% to about 40%, about 30% to about 45%, about 30% to about 50%, about 30% to about 60%, about 30% to about 75%, about 35% to about 40%, about 35% to about 45%, about 35% to about 50%, about 35% to about 60%, about 35% to about 75%, about 40% to about 45%, about 40% to about 50%, about 40% to about 60%, about 40% to about 75%, about 45% to about 50%, about 45% to about 60%, about 45% to about 75%, about 50% to about 60%, about 50% to about 75%, or about 60% to about 75%, including increments therein. In some embodiments, the device 1000 has a height in the collapsed state of less than the height in the expanded state by about 10%, about 15%, about 20%, about 25%, about 30%, about 35%, about 40%, about 45%, about 50%, about 60%, or about 75%. In some embodiments, the device 1000 has a height in the collapsed state of less than the height in the expanded state by at least about 10%, about 15%, about 20%, about 25%, about 30%, about 35%, about 40%, about 45%, about 50%, or about 60%. In some embodiments, the device 1000 has a height in the collapsed state of less than the height in the expanded state by at most about 15%, about 20%, about 25%, about 30%, about 35%, about 40%, about 45%, about 50%, about 60%, or about 75%.

In some embodiments, the compression chamber 100 comprises a base 120 and two or more walls 110. As shown, in FIGS. 2-8B, in one example the compression chamber 100 comprises a rectangular base 120 and four walls 110. Alternatively, in some embodiments, the base 120 has a shape comprising a circle, an oval, or a polygon, such as a triangle, a square, a rectangle a pentagon, or a hexagon. In some embodiments, the base 120 has a shape comprising a polygon, or an irregular shape. In some embodiments, the compression chamber 100 has a number of walls 110 equal to a number of sides of the base 120. In some embodiments, the compression chamber 100 has a number of walls 110 greater than a number of sides of the base 120. In some embodiments, the compression chamber 100 has a number of walls 110 less than a number of sides of the base 120. In some cases, the base 100 may be sized according to the type of tissue sample as illustrated in Table 1. In some cases, the base 120 may be square with a width and length of about 0.5 inches by 0.5 inches, 1 inch by 1 inch, 2 inches by 2 inches, 3 inches by 3 inches, or 4 inches by 4 inches. In some cases, a square base 120 may be less than 0.5 inches by 0.5 inches. In some cases, a square base 120 may be greater than 4 inches by 4 inches. In some cases, the base 120 may be rectangular with a width and length of about 4 inches by 3 inches.

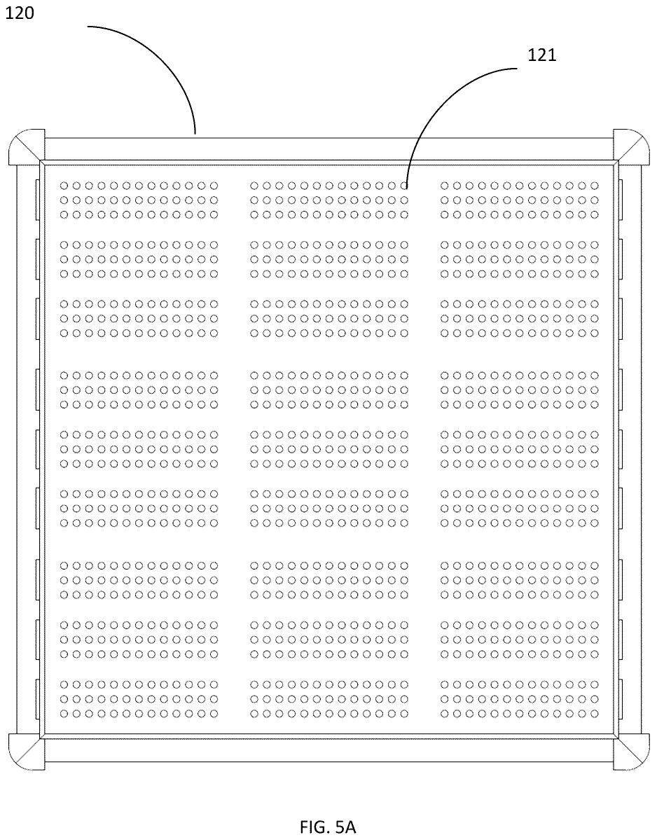

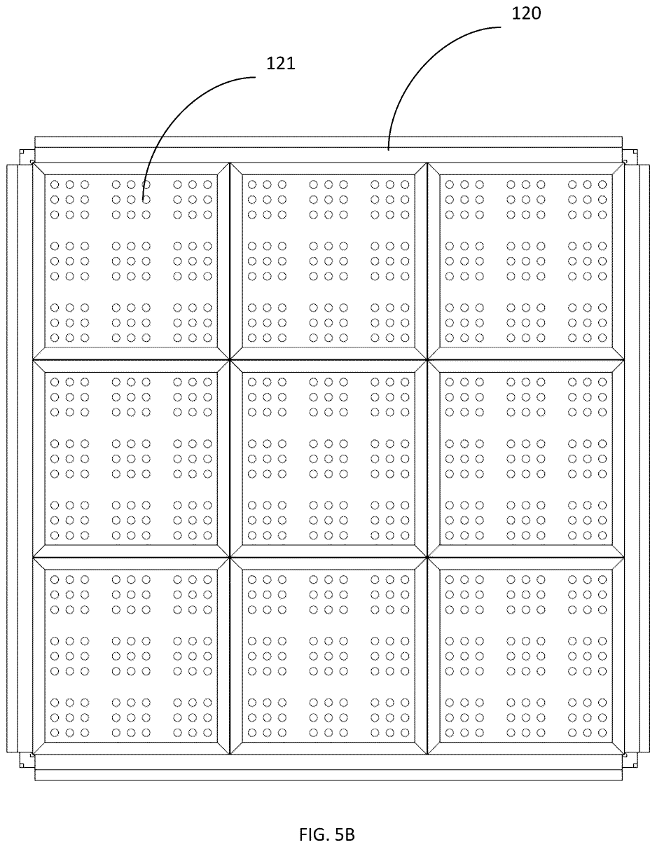

In some embodiments, the base 120 comprises a base filtration opening 121 therethrough. In some embodiments, as illustrated in FIGS. 5A-5B, the base 120 comprises an array of the base filtration openings 121. In some embodiments, as shown, the array of base filtration openings 121 is a rectilinear array. Alternatively, in some embodiments, the array of base filtration openings 121 comprise a polar array, a polygonal array, or an irregular array. Further, as shown, in some embodiments, the base 120 comprises a first portion having less base filtration openings 121 than a second portion, wherein the first portion and the second portion have equal areas.

In some cases, the plunger 200 can include filtration openings in a similar described herein as for the base 120 and the base filtration opening 121. In some cases, the filtration openings can be molded into the plunger 200. In some cases, the filtration openings can be releasably coupled to the plunger 200. In some cases, the plunger 200 can include an array of the filtration openings. In some cases, the array of filtration openings can include a rectilinear array. Alternatively, in some cases, the array of filtration openings can include a polar array, a polygonal array, or an irregular array. Further, in some cases, the plunger 200 can include a first portion having less filtration openings than a second portion. In some cases, the first portion and the second portion have equal areas.

In some embodiments, the walls 110 and base 120 shape of the compression chamber 100 is optimized for a particular type of tissue sample (e.g., lymph tissue associated with breast cancer). The ratios between the height, width, and/or length of the walls 110 and base 120 and/or with respect to the size of the filtration openings may be selected to remove the greatest percentage of fat tissue from the sample tissue with a single compression. In some cases, the selected ratios can preserve the lymph node morphology during a single compression. The geometry of the compression chamber 100 may be tuned for a specific tissue sample type based on a ratio between the fat tissue and the fibrous tissue in the sample tissue. In some cases, the ratio may be expressed as a ratio of the width, length, or both of the base 120 to the diameter of the base filtration opening.

In some embodiments, a ratio between a width, a length, or both of the base 120 to a diameter of the base filtration opening 121 is about 40:1 to about 120:1. In some embodiments, a ratio between a width, a length, or both of the base 120 to a diameter of the base filtration opening 121 is about 40:1 to about 50:1, about 40:1 to about 60:1, about 40:1 to about 70:1, about 40:1 to about 80:1, about 40:1 to about 90:1, about 40:1 to about 110:1, about 40:1 to about 45:1, about 40:1 to about 120:1, about 50:1 to about 60:1, about 50:1 to about 70:1, about 50:1 to about 80:1, about 50:1 to about 90:1, about 50:1 to about 110:1, about 50:1 to about 45:1, about 50:1 to about 120:1, about 60:1 to about 70:1, about 60:1 to about 80:1, about 60:1 to about 90:1, about 60:1 to about 110:1, about 60:1 to about 45:1, about 60:1 to about 120:1, about 70:1 to about 80:1, about 70:1 to about 90:1, about 70:1 to about 110:1, about 70:1 to about 45:1, about 70:1 to about 120:1, about 80:1 to about 90:1, about 80:1 to about 110:1, about 80:1 to about 45:1, about 80:1 to about 120:1, about 90:1 to about 110:1, about 90:1 to about 45:1, about 90:1 to about 120:1, about 110:1 to about 45:1, about 110:1 to about 120:1, or about 45:1 to about 120:1, including increments therein. In some embodiments, a ratio between a width, a length, or both of the base 120 to a diameter of the base filtration opening 121 is about 40:1, about 50:1, about 60:1, about 70:1, about 80:1, about 90:1, about 110:1, about 45:1, or about 120:1. In some embodiments, a ratio between a width, a length, or both of the base 120 to a diameter of the base filtration opening 121 is at least about 40:1, about 50:1, about 60:1, about 70:1, about 80:1, about 90:1, about 110:1, or about 45:1. In some embodiments, a ratio between a width, a length, or both of the base 120 to a diameter of the base filtration opening 121 is at most about 50:1, about 60:1, about 70:1, about 80:1, about 90:1, about 110:1, about 45:1, or about 120:1. In some cases, the ratio may be expressed as a ratio between the total surface area of the upper surface of the base 120 and a total surface area of the base filtration openings 121.

In some embodiments, a ratio between the total surface area of the upper surface of the base 120 and a total surface area of the base filtration openings 121 is about 2:1 to about 15:1. In some embodiments, a ratio between the total surface area of the upper surface of the base 120 and a total surface area of the base filtration openings 121 is about 2:1 to about 3:1, about 2:1 to about 4:1, about 2:1 to about 5:1, about 2:1 to about 7:1, about 2:1 to about 9:1, about 2:1 to about 11:1, about 2:1 to about 13:1, about 2:1 to about 15:1, about 3:1 to about 4:1, about 3:1 to about 5:1, about 3:1 to about 7:1, about 3:1 to about 9:1, about 3:1 to about 11:1, about 3:1 to about 13:1, about 3:1 to about 15:1, about 4:1 to about 5:1, about 4:1 to about 7:1, about 4:1 to about 9:1, about 4:1 to about 11:1, about 4:1 to about 13:1, about 4:1 to about 15:1, about 5:1 to about 7:1, about 5:1 to about 9:1, about 5:1 to about 11:1, about 5:1 to about 13:1, about 5:1 to about 15:1, about 7:1 to about 9:1, about 7:1 to about 11:1, about 7:1 to about 13:1, about 7:1 to about 15:1, about 9:1 to about 11:1, about 9:1 to about 13:1, about 9:1 to about 15:1, about 11:1 to about 13:1, about 11:1 to about 15:1, or about 13:1 to about 15:1, including increments therein. In some embodiments, a ratio between the total surface area of the upper surface of the base 120 and a total surface area of the base filtration openings 121 is about 2:1, about 3:1, about 4:1, about 5:1, about 7:1, about 9:1, about 11:1, about 13:1, or about 15:1. In some embodiments, a ratio between the total surface area of the upper surface of the base 120 and a total surface area of the base filtration openings 121 is at least about 2:1, about 3:1, about 4:1, about 5:1, about 7:1, about 9:1, about 11:1, or about 13:1. In some embodiments, a ratio between the total surface area of the upper surface of the base 120 and a total surface area of the base filtration openings 121 is at most about 3:1, about 4:1, about 5:1, about 7:1, about 9:1, about 11:1, about 13:1, or about 15:1.

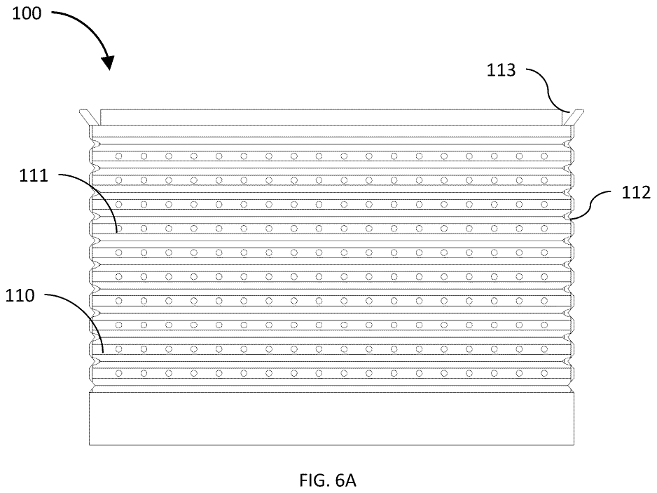

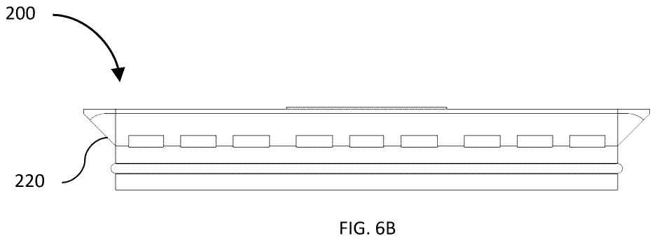

In some embodiments, as illustrated in FIG. 6A, one or more of the walls 110 comprises an array of the wall filtration openings 111. As shown, in some embodiments, the array of wall filtration openings 111 is rectilinear. Alternatively, in some embodiments, the array of wall filtration openings 111 comprises a polar array, a polygonal array, or an irregular array.

In some embodiments, a ratio between a width, a length, or both of the two or more walls 110 to a diameter of the wall filtration opening 111 is about 30:1 to about 70:1. In some embodiments, a ratio between a width, a length, or both of the two or more walls 110 to a diameter of the wall filtration opening 111 is about 30:1 to about 35:1, about 30:1 to about 40:1, about 30:1 to about 45:1, about 30:1 to about 50:1, about 30:1 to about 55:1, about 30:1 to about 60:1, about 30:1 to about 65:1, about 30:1 to about 70:1, about 35:1 to about 40:1, about 35:1 to about 45:1, about 35:1 to about 50:1, about 35:1 to about 55:1, about 35:1 to about 60:1, about 35:1 to about 65:1, about 35:1 to about 70:1, about 40:1 to about 45:1, about 40:1 to about 50:1, about 40:1 to about 55:1, about 40:1 to about 60:1, about 40:1 to about 65:1, about 40:1 to about 70:1, about 45:1 to about 50:1, about 45:1 to about 55:1, about 45:1 to about 60:1, about 45:1 to about 65:1, about 45:1 to about 70:1, about 50:1 to about 55:1, about 50:1 to about 60:1, about 50:1 to about 65:1, about 50:1 to about 70:1, about 55:1 to about 60:1, about 55:1 to about 65:1, about 55:1 to about 70:1, about 60:1 to about 65:1, about 60:1 to about 70:1, or about 65:1 to about 70:1, including increments therein. In some embodiments, a ratio between a width, a length, or both of the two or more walls 110 to a diameter of the wall filtration opening 111 is about 30:1, about 35:1, about 40:1, about 45:1, about 50:1, about 55:1, about 60:1, about 65:1, or about 70:1. In some embodiments, a ratio between a width, a length, or both of the two or more walls 110 to a diameter of the wall filtration opening 111 is at least about 30:1, about 35:1, about 40:1, about 45:1, about 50:1, about 55:1, about 60:1, or about 65:1. In some embodiments, a ratio between a width, a length, or both of the two or more walls 110 to a diameter of the wall filtration opening 111 is at most about 35:1, about 40:1, about 45:1, about 50:1, about 55:1, about 60:1, about 65:1, or about 70:1.

In some embodiments, the array of base filtration openings 121 and the array of wall filtration opening 111 array are congruent. In some embodiments, the array of base filtration openings 121 and the array of wall filtration opening 111 array are incongruous.

In some embodiments, the size and arrangement of the wall filtration openings 111, the base filtration openings 121, or both is optimized for a particular type of tissue sample (e.g., lymph tissue associated with breast cancer). The geometry of the filtration openings may be selected to remove the greatest percentage of fat tissue from the sample tissue with a single compression. In some cases, the geometry of the filtration openings can preserve the lymph node morphology during a single compression. The geometry of the filtration openings may be tuned for a specific tissue sample type based on a ratio between the fat tissue and the fibrous tissue in the sample tissue.

In some embodiments, as shown, the two or more of the two or more walls 110 have a congruent shape. Alternatively, in some embodiments, two or more of the two or more walls 110 have an incongruent shape. In some embodiments, two or more of the two or more walls 110 have equal widths. In some embodiments, one or more of the two or more walls 110 have a width greater than a width of another walls 110. In some embodiments, as shown, the two or more of the two or more walls 110 have the same height. Alternatively, in some embodiments, as shown, the two or more of the two or more walls 110 have different heights.

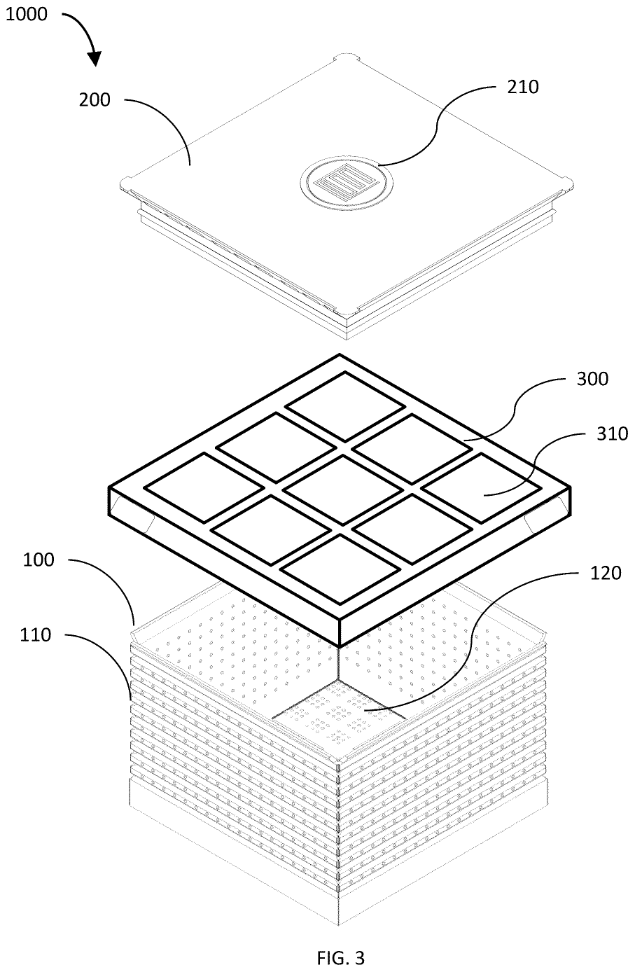

In some embodiments, as illustrated in FIG. 2A, an upper surface of the base 120 comprises a tissue template 130 or 300. In some embodiments, as illustrated in FIG. 3, the tissue template 300 is removable from the base 120. In some cases, the tissue template 130 or 300 can be molded into the base 120. In some embodiments, the tissue template 300 removably couples to the base 120 with a magnet, a pin, a clip, a hook and loop fastener, a tie, a screw, a nut, a bolt, or any combination thereof. In some cases, the tissue template 130 or 300 can be molded into the plunger 200. In some cases, the tissue template 130 or 300 can be removably coupled to the plunger 200 with a magnet, a pin, a clip, a hook and loop fastener, a tie, a screw, a nut, a bolt, or any combination thereof. In some embodiments, as shown, the tissue template 130 or 300 comprises nine congruent chambers that form a rectilinear array. Alternatively, in some embodiments, the tissue chamber 130 or 300 comprises a square number of chambers. In some embodiments, the array of chambers alternatively comprises a polar array, a polygonal, or an irregular array. In some embodiments, one or more of the walls dividing the chambers are drafted inward, to divide the tissue samples into each chamber. In some cases, the tissue template 130 or 300 can be subdivided into at least 1, 2, 3, 4, 5, 6, 7, 8, 9 or more sub-chambers or wells. In some cases, the tissue template 130 or 300 can be subdivided into at most 9, 8, 7, 6, 5, 4, 3, 2 or less sub-chambers or wells. In some cases, the tissue template 130 or 300 can be subdivided into one sub-chamber, e.g., may not cut, slice, or divide the tissue sample.

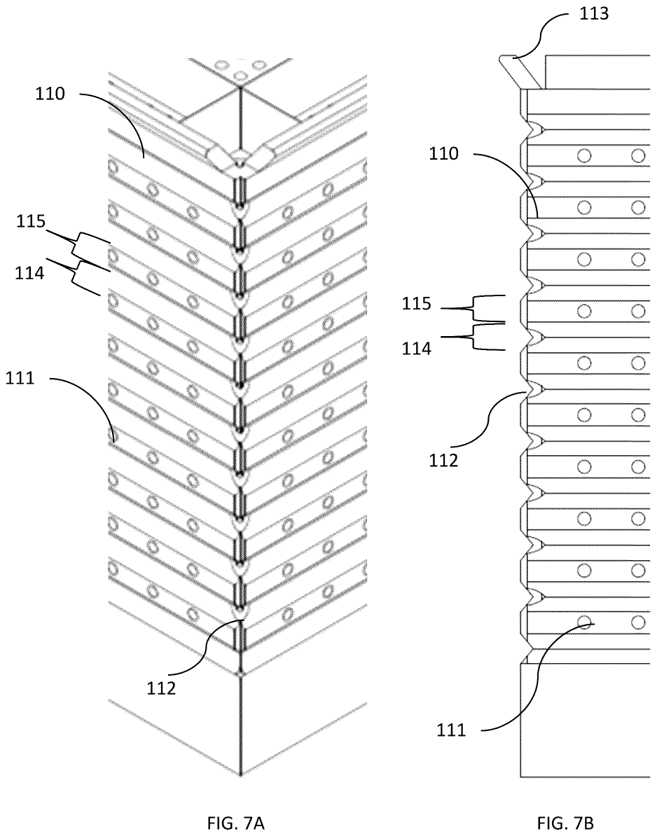

In some embodiments, two of the walls 110 are detachably coupled in the expanded state. In some embodiments, as illustrated in FIGS. 7A-7B, two of the walls 110 are detachably coupled by a perforation 112. As shown, the perforations 112 pierce the compression chamber 100. In some embodiments, the two or more walls 110 are reattachable. In some embodiments, the perforations 112 are designed to decouple under pressure from the plunger 200. In some embodiments, the two or more walls 110 are reattachable by a hook, a loop, a magnet, a snap, or any combination thereof.

In some embodiments, the size and arrangement of the perforations 112 are optimized for a particular type of tissue sample (e.g., lymph tissue associated with breast cancer). The geometry of the perforations 112 may be selected to impart a consistent pressure on the tissue sample to remove the greatest percentage of fat tissue from the sample tissue with a single compression. The geometry of the perforations 112, the compression chamber 100, or both may be selected to withstand a compression force of at least about 200 psi. The geometry of the perforations 112, the compression chamber 100, or both may be selected to withstand a compression force of at most about 800 psi, wherein further strengthening to exceed such higher pressures may be cost prohibitive. The geometry of the perforations 112 may be tuned for a specific tissue sample type based on a ratio between the fat tissue and the fibrous tissue in the sample tissue. Perforations 112 may be accompanied by, or substituted with, one or more tear lines, to facilitate the detachable coupling.

In some embodiments, as illustrated in FIGS. 7A-7B, at least one of the two or more walls 110 comprises a flexure portion and a rigid portion, and wherein the flexure portion is thinner than the rigid portion. In some embodiments, at least a part of the flexure portion is parallel to the base 120. In some embodiments, at least one of the two or more walls 110 comprises a plurality of flexure portions, wherein at least two of the plurality of flexure portions are parallel. As shown, in one embodiment, the entire height of the walls 110 comprises a series of flexure and rigid portions. Alternatively, at most a portion of the height of the walls 110 comprises a series of flexure and rigid portions. In some embodiments, the flexure and rigid portions have equal widths. In some embodiments, the flexure portions are each wider than the rigid portions. In some embodiments, the flexure portions are each narrower than the rigid portions.

In some embodiments, the size and arrangement of the flexure portions and rigid portions are optimized for a particular type of tissue sample (e.g., lymph tissue associated with breast cancer). The geometry of the flexure portions and rigid portions may be selected to impart a consistent pressure on the tissue sample to remove the greatest percentage of fat tissue from the sample tissue with a single compression. The geometry of the flexure portions and rigid portions may be tuned for a specific tissue sample type based on a ratio between the fat tissue and the fibrous tissue in the sample tissue.

In some embodiments, as illustrated in FIGS. 6A and 7B, an upper face of the two or more walls 110 comprises a wall chamfer 113. The wall chamfer 113 may ensure that the plunger 200 is aligned with the cavity of the compression chamber 100. The wall chamfer 113 may also deflect a downwards force applied to the plunger 200 outward at an angle to detach the walls 110 and convert the compression chamber 100 from its expanded state to its compressed state.

In some embodiments, at least a proximal portion of the plunger 200 is removably receivable within the cavity of the compression chamber 100. In some embodiments, an outer face of the plunger 200 comprises a plunger chamfer 220. The plunger chamfer 220 may ensure that the plunger 200 is aligned with the cavity of the compression chamber 100. The plunger chamfer 220 may also deflect a downwards force applied to the plunger 200 outward at an angle to detach the walls 110 and convert the compression chamber 100 from its expanded state to its compressed state.

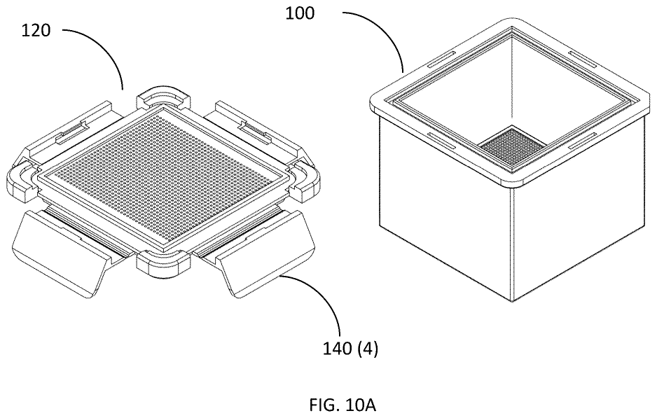

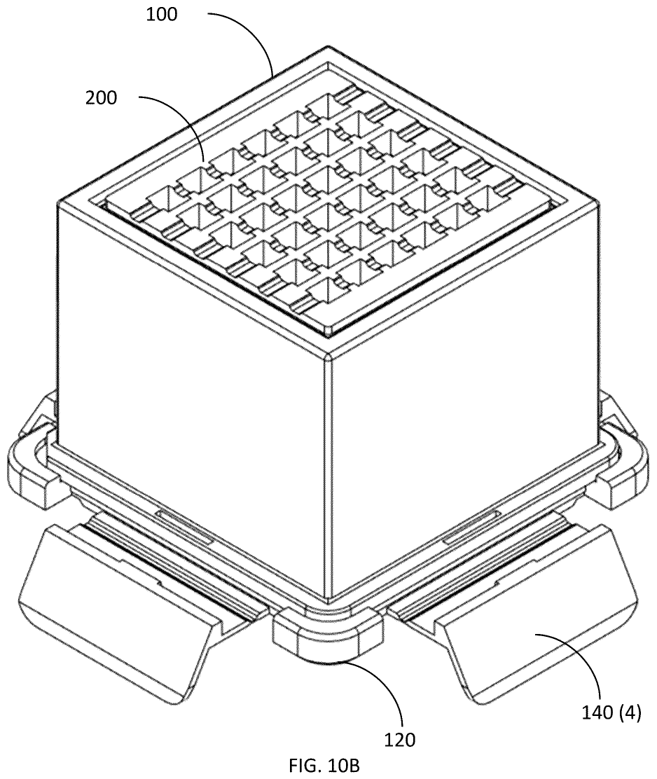

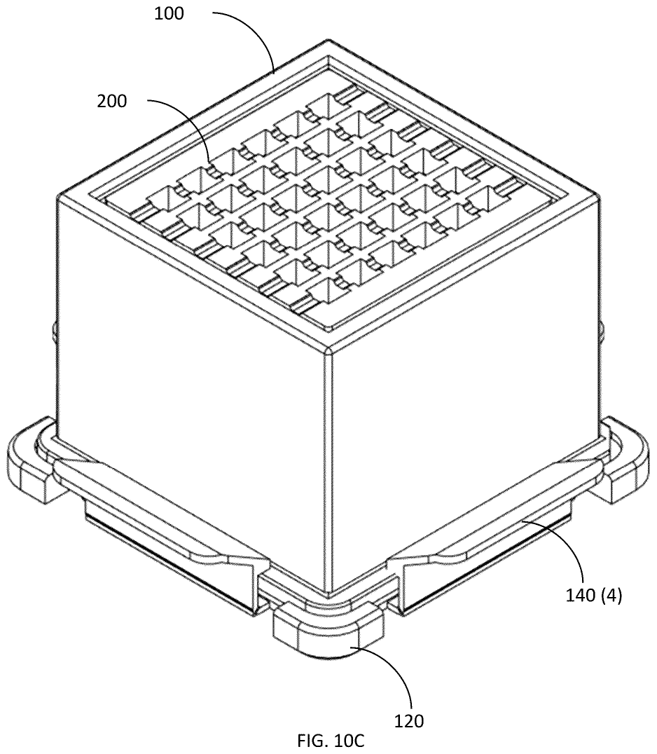

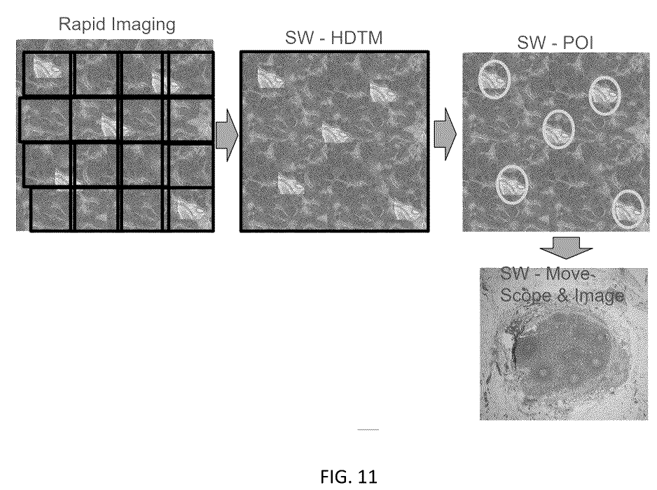

In some cases, the base 120 can be releasably coupled to the compression chamber 100 using a hook, a loop, a magnet, a snap, or any combination thereof. In some cases, as illustrated in FIGS. 10A-10C, the base 120 can be releasably coupled to the compression chamber 100 using one or more snap features 140. FIG. 10A shows a perspective view of the base 120 and the compression chamber 100 in an unassembled or decoupled state. FIG. 10B shows a perspective view of the base and compression chamber in an assembled or coupled state with the snap features 140 in the open or unsnapped position. FIG. 10C shows a perspective view of the base 120 and the compression chamber 100 in an assembled or coupled state with the snap features 140 in the closed or snapped position. In some cases, each one of the snap features 140 (e.g., 4 snaps) may be hingedly coupled to each side or edge (e.g., 4 sides or edges) of the base 120. In some cases, each snap feature 140 may be configured with one or more extruded features or tabs (e.g., 1 tab) that extrude from an edge of the snap feature 140. In some cases, each side or edge of the base 120 may be configured with one or more recessed features or indentations (e.g., 4 indentations) that recede into an edge of the base 120. In some cases, the one or more indentations of the base 120 are sized to operatively receive the one or more tabs of each snap feature 140 by a snap fit. In some cases, each of the snap features 140 may be configured with a handle feature that enables a user to operate each snap feature 140 thereby coupling or securing the base 120 to the compression chamber 100.

### Systems for Collecting or Processing a Tissue Sample

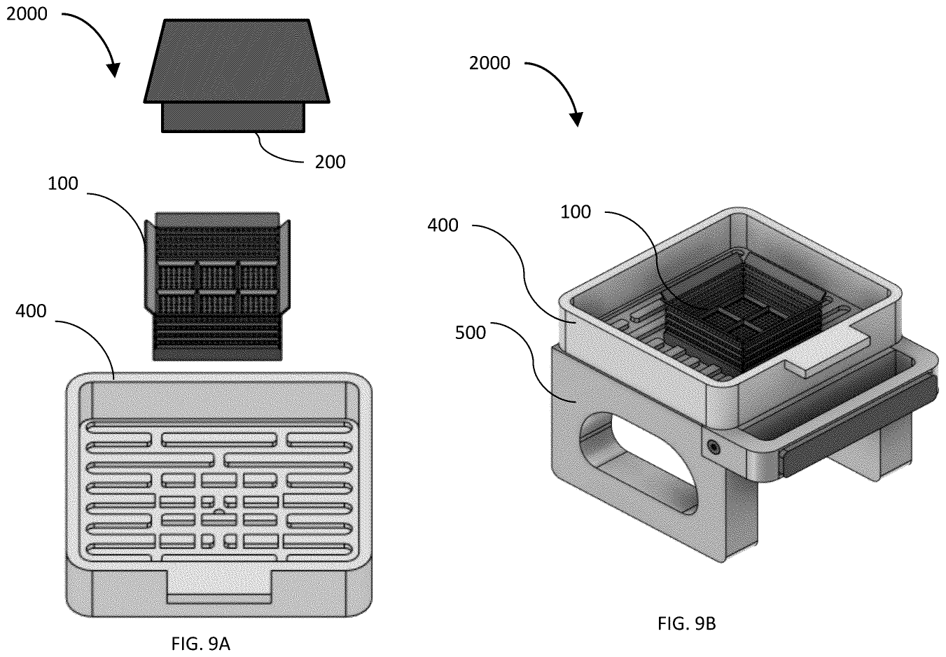

Another aspect provided herein, as illustrated in FIGS. 9A-9B, is a system 2000 for collecting a tissue sample. As shown, the system 2000 comprises the device 1000 for collecting a tissue sample, herein, a fat drainage dish 400 removably coupled to the device 1000, and a compression platform 500 supporting the fat drainage dish 400.

In some cases, the system can be configured to locate the variably sized filters and to direct liquid adipose (e.g., fat) to a catch container below the device 1000 for storage and further analysis. In some cases, the fat drainage dish 400 is configured to facilitate the flow of the liquid adipose through a series of mechanical operations during the compression cycle of the compression chamber 100. Mechanical operations can include opening a gate within the device 1000 and allowing the liquid adipose to flow from one compartment in the system to another under the force of gravity. The flow may be directed by patterns in the fat drainage dish 400 consisting of shapes or grooves designed for fat flow. In some cases, the grooves can also simplify cleaning for end users while wearing gloves. The system can also be configured to measure the total amount of mass transferred from the tissue sample to the catch container through embedded sensors that monitor changes in the tissue sample's mass.

In some embodiments, the fat drainage dish 400 is removably coupled to the device 1000 by a snap fit, a dowel rod, a magnet, or any combination thereof. In some embodiments, the fat drainage dish 400 comprises a plurality of channels for collecting the drained fat. The compression platform 500 may be configured to withstand the pressure applied to the plunger 200. The compression platform 500 may aid in the collection of fat tissue emitted from the compressed tissue sample.

### Methods for Collecting or Processing a Tissue Sample

Another aspect provided herein is a method of collecting a tissue sample, the method comprising: (a) receiving the system for collecting a tissue sample herein; (b) receiving the tissue sample; (c) applying the tissue sample to the base of the compression chamber; (d) positioning at least the portion of the plunger within the cavity; (e) positioning the compression chamber on the fat drainage dish; (f) positioning the fat drainage dish on the compression platform; and (g) applying pressure to the plunger.

In some embodiments, the applied pressure is at least about 200 psi, 250 psi, 300 psi, 350 psi, 400 psi, 450 psi, 500 psi, 550 psi, 600 psi, 750 psi, or 800 psi including increments therein. The applied pressure may correlate to a ratio between the fat tissue and the fibrous tissue in the sample, wherein a higher composition of fat tissue requires a lower pressure. In some embodiments, applying pressure to the plunger transforms the compression chamber from the expanded state to the compressed state. In some embodiments, the method further comprises applying a solvent to the tissue sample. In some embodiments, a tissue template divider separates the tissue sample into two or more portions. In some embodiments, each portion of the tissue sample is analyzed separately. In some embodiments, a position of the tissue sample portion is denoted to maintain morphology. In some embodiments, the applied pressure in step (g) is selected based on a size of the device or system for collecting a tissue sample, a volume of the sample, a mass of the tissue samples, a type of sample, or any combination thereof.

For example, Table 1 illustrates nonlimiting examples of different sizes of device 1000 that can be used for different masses and sizes of tissue samples. FIGS. 2B-2D illustrate plan views of exemplary devices sized according to a size of the tissue sample. For example, FIG. 2B illustrates device 1000 sized with a square base 120 having a length and width of about 4 inches by 4 inches (e.g., 3.94 by 3.94 inches or 100 by 100 mm) for collecting tissue samples of size about 80 mm by 80 mm or mass about 200 grams. For example, FIG. 2C illustrates device 1000 sized with a square base 120 having a length and width of about 3 inches by 3 inches (e.g., 3.15 by 3.15 inches or 80 by 80 mm) for collecting tissue samples of size about 60 mm by 60 mm or mass about 100 grams. For example, FIG. 2D illustrates device 1000 sized with a rectangular base 120 having a length and width of about 4 inches by 3 inches (e.g., 3.94 by 3.15 inches or 100 by 80 mm) for collecting tissue samples of size about 80 mm by 60 mm or mass about 150 grams.

TABLE 1

| Device embodiment | Mass of tissue | Size of tissue |
|---|---|---|
| (inches) | sample (grams) | sample (mm) |
| About 1 × 1 | About 25 | About 20 × 20 × 3 |
| About 2 × 2 | About 50 | About 40 × 40 × 3 |
| About 3 × 3 | About 100 | About 60 × 60 × 3 |
| About 4 × 3 | About 150 | About 80 × 60 × 3 |
| About 4 × 4 | About 200 | About 80 × 80 × 3 |

In some cases, methods herein may generate a liquified adipose tissue or fat filtrate that is not altered (e.g., heated or chemically altered) by the device filtration. In some cases, methods herein can maintain the morphology and relative location of the lymph nodes in a tissue sample. The fat filtrate can be further analyzed for its microscopic cellular or molecular content. Analysis can include at least wide area mapping by digital imaging, generating a low resolution tissue mosaic, using software to detect of areas of interest for further analysis, imaging certain areas of interest, or analyzing certain areas of interest. Analysis can include generating a high resolution tissue mosaic by using a microscope to capture a plurality of images and to stitch the images together. In some cases, the fat filtrate may be devoid of or substantially devoid of most solid tissue. In some cases, the fat filtrate can be safely stored proximate to other fluids, e.g., in a container. In some cases, the fat filtrate may be discarded following analysis of the lymph nodes and remaining tissue samples.

In some embodiments, the method further comprises scanning an RFID tag of system for collecting a tissue sample. In some embodiments, the applied pressure is designated in the RFID tag based on the tissue sample associated with the RFID tag.

In some cases, methods herein may use a marker, beacon, or indicator of any kind embedded in the device 100, which can be configured to transmit a communication or control signal to the control software. The communication or control signal can be configured to alert the control software to predetermined events. The control software may receive the communication or control signal and correlate metadata embedded in the communication or control signal to different data. Different data can include consumable type, tissue sample type, patient id, patient type, product id, batch id, or any other data relevant to performing the methods herein. This data can allow for more accurate system control, e.g., pressure output, as well as traceability and data transmission from the device 1000 to any third-party software applications. Data can be transmitted and received through application programming interfaces (APIs). In some cases, the marker, beacon, or indicator may be associated with a function of the device 1000. For example, Table 2 illustrates different types of sensors that may be used to perform different types of sensing.

TABLE 2

| Sensing | Examples |
|---|---|
| Vision or imaging | Camera and barcode |
| Radio - RFID | RFID reader and RFID tag |
| | NFC reader and NFC tag |
| Proximity | Hall Effect Sensor and Magnet |
| Pressure | Mechanical part and switch |

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

While preferred embodiments of the present disclosure have been shown and described herein, such embodiments are provided by way of example. Numerous variations, changes, and substitutions will now occur without departing from the present disclosure. It can be understood that various alternatives to the embodiments of the present disclosure described herein may be employed in practicing the present disclosure. It is intended that the following claims define the scope of the present disclosure and that methods and structures within the scope of these claims and their equivalents be covered thereby.

### EXAMPLES

### Example 1—Testing and Validating Devices Using Patient Tissue Samples

Pathology labs may identify lymph nodes using different methods. For example, pathology labs may use methods such as manual palpation or visual search of resected fatty tissue. However, compared to the present disclosure, such methods can be inefficient, inaccurate, time intensive, or costly. For example, such methods can take 45 minutes or longer to perform a comprehensive search for lymph nodes. Also, such methods can produce variable and unreliable results because they may rely on a user (e.g., a pathologist's or pathology assistant's) to manually perform the methods. The user may have insufficient experience or training or be distracted by the user's daily workload. Despite these technical challenges in providing accurate or confident pathology results, governing bodies continue to emphasize the importance of a comprehensive lymph node search. For example, the American Joint Committee on Cancer (AJCC) issued guidelines for the minimal number of lymph nodes that must be identified or examined in a variety of cancer surgeries. For colon and rectum samples, the AJCC states that “the likelihood of detecting metastasis increases with the number of lymph nodes examined; hence 12 lymph nodes should be considered a minimum target, but all possible lymph nodes should be retrieved and examined.” Nicastri, Daniel G., et al. “Is occult lymph node disease in colorectal cancer patients clinically significant?: A review of the relevant literature,” The Journal of molecular diagnostics 9.5 (2007): 563-571, which is hereby incorporated by reference in its entirety.

To determine and validate performance of the present disclosure against the AJCC guidelines, devices herein were tested and validated using patient tissue samples from segmental colonic resections. Segmental colonic resections included right colectomy, transverse colectomy, left colectomy, sigmoidectomy, and rectal resection. Devices herein were able to identify at least more than the AJCC guideline of 12 lymph nodes in each of the patient tissue samples processed by the devices herein. For example, devices herein identified about 25 to 50 lymph nodes in each of the right colectomy samples, about 12 to 25 lymph nodes in each of the transverse colectomy samples, about 28 to 40 lymph nodes in each of the left colectomy samples, about 22 to 38 lymph nodes in each of the sigmoidectomy samples, and about 25 to 40 lymph nodes in each of the rectal resection samples.

In some cases, guidelines other than the AJCC guidelines can be used. For example, a Nodal Staging Score (NSS) can be used. Devices herein also were also tested and validated according to achieving a NSS sufficient to identify a patient as pN0, e.g., there are no cancer cells in any nearby lymph nodes or only small clusters of cancer cells less than 0.2 mm across. Devices herein were able to achieve a NSS of least about 95% in 50% of samples tested. Compared to other methods such as manual dissection of tissue samples, devices herein achieved at least an improvement of 10% in accurately identifying lymph nodes. Also, devices herein were able to identify extranodal tumor deposits and foci of lymphovascular invasion in mesenteric and pericolic adipose tissue. Such improved accuracy can provide greater confidence that a patient is appropriately staged as pN0. The testing and validation herein may suggest that the present disclosure may be suitable for routine use in pathology labs and pathology workups.

### Example 2—Determining Tissue Compressive Force

In some cases, the force exerted by the actuator (e.g., actuator for the hydraulic plunger) can be linearly proportional to the current running through the actuator. Accordingly, in some cases, the force on the sample can be indirectly measured by measuring the electrical current through the actuator. To characterize this linear relationship, a calibration function or process can be performed. The calibration function or process can include measuring the electrical current through the actuator at various applied forces by using a compressive load cell to determine a set of data points, e.g., electrical current versus force. A linear relationship can be determined by fitting a line to these data points, which describes the electrical current and force relationship. In some cases, the calibration function or process can include validating that the morphology of the tissue sample is substantially maintained up to a threshold amount of force or pounds per square inch (psi), which can be unique to each type of tissue sample. The threshold or maximum allowable force can be determined through the relationship: pressure=force/area, where A is the cross sectional area to which the force is being applied evenly, all in coherent units. Then, the calibration function or process can include determining the threshold pressure, obtaining the cross sectional area from the tissue chamber, determining the maximum allowable or threshold force, and determining the maximum allowable current.

In some cases, after the calibration function or process, a control signal can be sent to the actuator to enable motion at a certain speed, and a stop signal can be sent to the actuator when the system registers or detects the maximum allowable electrical current. In some cases, the maximum allowable electrical current can be normalized for noise. In some cases, the system can include position feedback from the actuator. For example, position feedback can be received or determined and used to control the actuator by commanding it to move to different positions relative to the tissue sample.

In some cases, there may be a standard thickness of the compressed tissue sample that is optimal for separating the top and bottom sections of the compression chamber. Accordingly, the stopping point or position of the actuator can be balanced between achieving the optimal position and reaching the maximum allowable force or electrical current. After the actuator reaches the maximum allowable force or electrical current on the first pecking cycle, the actuator can be slightly retracted and then compressed again until either the actuator reaches the desired position or reaches the maximum allowable force or electrical current again. The pecking process can be repeated for multiple cycles based on sample tissue type but may stop before a predetermined cycle (e.g., 6th pecking cycle) if it achieves the desired position for an ideal tissue cake first. In some cases, the load cell used in the compression drawer can measure the known mass of the chamber and plunger along with the mass of the tissue sample. The measurements can be used to calibrate this desired position more accurately on a sample by sample basis. Measuring the mass of the chamber and sample after compression can also be helpful in collecting information or data on how much fat was expelled from the tissue sample.

In some cases, the number of pecking cycles, maximum allowable pressure, force, or electrical current, or optimal end position can also be controlled based on information or data entered by the user from a command line or a user interface (e.g., graphical user interface (GUI)). In some cases, the number of pecking cycles, maximum allowable pressure, force, or electrical current, or optimal end position can be extracted automatically from a sensor or chip embedded in the compression chamber.

1. A device for collecting a tissue sample, the device comprising:
a compression chamber having an expanded state and a compressed state, the compression chamber comprising:
(i) a base comprising a base filtration opening therethrough, wherein an upper surface of the base comprises a tissue template, and
(ii) two or more walls extending from the base, wherein at least one of the two or more walls comprises a wall filtration opening therethrough, and wherein two of the two or more walls are detachably coupled in the expanded state; and
a plunger, wherein at least a proximal portion of the plunger is removably receivable within the compression chamber.

2. The device of claim 1, wherein the base comprises an array of base filtration openings therethrough, and wherein one or more of the two or more walls comprises an array of wall filtration openings.

3. The device of claim 2, wherein the array of base filtration openings, the array of wall filtration openings, or both, comprise a polar array, a rectilinear array, a polygonal array, or an irregular array.

4. The device of claim 2, wherein the array of base filtration openings and the array of wall filtration openings are congruent.

5. The device of claim 2, wherein the array of base filtration openings and the array of wall filtration openings are incongruous.

6. The device of claim 1, wherein the tissue template is removable from the base.

7. The device of claim 1, wherein the wherein-the-tissue template comprises a plurality of chambers.

8. The device of claim 7, wherein the plurality of chambers comprises an array of chambers.

9. The device of claim 8, wherein the array of chambers comprises a polar array, a rectilinear array, a polygonal, or an irregular array.

10. The device of claim 1, wherein an upper face of the two or more walls comprises a wall chamfer.

11. The device of claim 1, wherein an outer face of the plunger comprises a wall chamfer.

12. The device of claim 1, wherein the two or more walls are reattachable.

13. The device of claim 1, wherein two of the two or more walls are detachably coupled by a perforation.

14. The device of claim 1, wherein at least one of the two or more walls comprises a flexure portion and a rigid portion, and wherein the flexure portion is thinner than the rigid portion.

15. The device of claim 14, wherein at least a part of the flexure portion is parallel to the base.

16. The device of claim 15, wherein at least one of the two or more walls comprises a plurality of flexure portions, wherein at least two of the plurality of flexure portions are parallel.

17. The device of claim 1, wherein a ratio between a width, a length, or both of the base to a diameter of the base filtration opening is about 40:1 to about 120:1.

18. The device of claim 2, wherein a ratio between a total surface area of the upper surface of the base and a total surface area of the array of base filtration openings is about 2:1 to about 15:1.

19. The device of claim 1, wherein a ratio between a width, a length, or both of the two or more walls to a diameter of the wall filtration opening is about 30:1 to about 70:1.

20. The device of claim 1, wherein a height in the compressed state is less than a height in the expanded state by about 10% to about 75%.

21. The device of claim 1, further comprising an RFID tag, a barcode, a QR code, a Bluetooth device, a Wi-Fi device, or any combination thereof.

22. The device of claim 1, wherein the device is configured to achieve a Nodal Staging Score (NSS) of greater than or equal to 95% on at least about 50% of samples tested.

23. The device of claim 1, wherein the device is configured to achieve a Nodal Staging Score (NSS) of greater than or equal to 90% on at least about 85% of samples tested.

24. The device of claim 1, wherein the device is configured to extract at least about 50% more lymph nodes per volume than extraction by manual dissection.

25.-116. (canceled)
